(19) United States
(12) Patent Application Publication
(10) Pub. No.: US 2017/0121019 A1
(43) Pub. Date: May 4, 2017

(54) DRONE-TYPE SMART CARWASH ROBOT

(71) Applicant: INDUSTRIAL BANK OF KOREA, Seoul (KR)

(72) Inventors: Pilsoon Shin, Busan (KR); Jongman Kwon, Gwangju-si (KR)

(21) Appl. No.: 14/926,309

(22) Filed: Oct. 29, 2015

(51) Int. Cl. B64C 39/02; G08G 5/00; B08B 1/00; B08B 13/00; B60S 3/04; B08B 3/04

(52) U.S. Cl. CPC B64C 39/024; B60S 3/04; B08B 3/04; B08B 1/006; B08B 13/00; G08G 5/003; B64C 2201/024; B64C 2201/165; B64C 2201/141; B64C 2201/12; B25J 11/0085

(57) ABSTRACT

The present invention provides a drone-type smart car wash robot. The drone-type smart car wash robot may detect dirty state information and shape information of a vehicle while flying around the vehicle in an unmanned manner, and allow car wash to be intelligently and automatically performed while flying according to a flight path calculated in a customized manner to correspond to the dirty state information and shape information and a car wash operation control signal, and therefore it is possible to minimize constraints of time and place for car wash and frequently perform car wash in a simple and easy manner.

### BACKGROUND

1. Field of the Invention

The present invention relates to a drone-type smart car wash robot, and more particularly, to a drone-type smart car wash robot which may detect dirty state information and shape information of a vehicle while flying around the vehicle in an unmanned manner, and then allow intelligent and automatic car wash to be performed while flying according to a flight path and a car wash operation control signal which are calculated in a customized manner in response to the dirty state information and the shape information, so that the car wash may be often simply and easily performed while constraints of time and place for car wash are minimized, and it may be ensured that only dirty areas of a reference value or more are washed, thereby reducing car wash costs and increasing car wash efficiency.

2. Discussion of Related Art

Car wash may be performed directly by a person, and also automatically performed by a car washing machine. Here, a typical car washing machine is an apparatus in which a plurality of brushes installed in horizontal and vertical directions perform car wash on a front surface, a top surface, a rear surface, and side surfaces of a vehicle while they are rotated, and is classified into a large car washing machine (applied to buses, trucks, etc.) and a general car washing machine (applied to passenger cars) depending on vehicle types and classified into a fixed car washing machine and a movable car washing machine depending on a washing method. The fixed car washing machine is a car washing machine in which car wash is carried out while a vehicle passes through the inside of a car wash case fixed and installed on the ground, and the movable car washing machine is a car washing machine in which car wash is carried out while the car wash case is moved forward and rearward directions in a state in which the vehicle is stopped.

However, these car washing machines have an advantage in which car wash is automatically simply and easily carried out, but are available only in a car wash equipped with the car washing machine so that there are constraints of time and place for car wash.

Meanwhile, the Republic of Korea Utility Model Registration No. 20-0261232 entitled “Cleaning device using small unmanned helicopter” discloses a technology in which the outside walls or glasses of a building are cleaned by a machine rather than directly by a person so that accidents that may occur when a cleaning operation is performed directly by the person may be prevented, and a cleaning device capable of cleaning the outside walls of the building even when the structure of the outside walls of the building is not simply flat is mounted in a small unmanned helicopter and an operator on the ground performs a cleaning operation while monitoring an operating environment through a distance sensor and a camera so that a delicate operation is made possible in response to changes in circumstances. However, it is necessary to increase car wash efficiency and minimize constraints of time and place for car wash, by applying this technology to car wash.

### SUMMARY OF THE INVENTION

The present invention is directed to a new drone-type smart car wash robot in which a vehicle scanning module may be provided in an aircraft module which is manually controlled by an operator on the ground or automatically maneuvered by a set flight program and flies around a vehicle in an unmanned manner so that scanning may be performed on a vehicle to be washed, and dirty state information and shape information of the vehicle and a flight path for performing car wash and a car wash operation control signal corresponding to these information may be calculated in a customized manner by a car wash preliminary information calculation algorithm, a flight path calculation algorithm, and a car wash operation control signal calculation algorithm of a controller, and therefore a car wash module of the aircraft module which flies along the flight path for performing car wash may intelligently and automatically perform car wash according to the car wash operation control signal calculated in the customized manner. As a result, it is possible to minimize constraints of time and place for car wash, and frequently perform car wash in a simple and easy manner.

The present invention is also directed to a new drone-type smart car wash robot in which only a dirty portion having a reference value or more may be washed through vehicle dirty state information calculated by a vehicle scanning module, thereby reducing car wash costs and increasing car wash efficiency.

The present invention is also directed to a new drone-type smart car wash robot in which state information of a portion (portion to be washed) having been washed may be detected by a car wash state detection module mounted in an aircraft module and car wash may be performed again when a dirty state value calculated from the state information of the portion to be washed is a dirty state reference value or more, and therefore car wash may be performed precisely and cleanly.

According to an aspect of the present invention, there is provided a drone-type smart car wash robot including: an aircraft module that flies in an unmanned manner by any one selected from manual operation by an operator on the ground and automatic maneuvering by a set flight program; a vehicle scanning module that is mounted in the aircraft module and performs scanning on a vehicle to be washed while moving integrally with the aircraft module; a car wash module that is mounted in the aircraft module and performs car wash while moving integrally with the aircraft module; and a controller that controls operations of the aircraft module, the vehicle scanning module, and the car wash module.

Here, the vehicle scanning module may include a three-dimensional (3D) scanner that performs 3D scanning on the vehicle to be washed and transmits vehicle scan information to the controller.

Also, the controller may include a car wash preliminary information calculation algorithm that calculates shape information and dirty state information of the vehicle to be washed from the vehicle scan information transmitted from the 3D scanner, and control the operations of the aircraft module and the car wash module according to the calculated shape information and dirty state information of the vehicle to be washed.

Also, the controller may further include a flight path calculation algorithm that calculates a flight path for performing car wash of the aircraft module corresponding to the shape information and dirty state information of the vehicle to be washed and a car wash operation control signal calculation algorithm that calculates a car wash operation control signal corresponding to the dirty state information of the vehicle to be washed, and control the car wash module according to the car wash operation control signal while controlling the aircraft module so that the aircraft module flies along the flight path for performing car wash in an unmanned manner.

Also, the drone-type smart car wash robot may further include a car wash state detection module that detects state information of a portion (a portion to be washed) in which car wash has been performed by the car wash module.

Also, the car wash state detection module may be any one of the car wash state detection module including a car wash state information detection sensor for detecting state information of the portion to be washed and the car wash state detection module integrated with the vehicle scanning module.

Also, the controller may include a dirty state value calculation algorithm that receives state information of the portion to be washed from the car wash state detection module and calculates a dirty state value from the state information of the portion to be washed, a dirtiness determination algorithm that determines, when a dirty state reference value is set, whether the dirty state value calculated from the dirty state value calculation algorithm is the set dirty state reference value or more, and a car wash re-performing control algorithm that generates, when the dirty state value calculated from the dirty state value calculation algorithm is the dirty state reference value or more, an operation control signal for controlling the operations of the aircraft module and the car wash module so that car wash on the portion to be washed is performed again.

Also, the aircraft module may include a main frame in which the vehicle scanning module and the car wash module are mounted, a vertical movement propulsion device that includes one or more propellers vertically installed in the main frame, and a horizontal movement propulsion device that includes one or more propellers horizontally installed in the main frame.

Also, the car wash module may include a washing liquid injection mechanism that injects a washing liquid, and a wiper that wipes a surface of the vehicle to be washed.

Also, the car wash module may protrude from a center portion of a bottom surface of the main frame of the aircraft module, and allow the washing liquid injection mechanism and the wiper to be fixed to a vertical support whose length is vertically adjusted.

Alternatively, the car wash module may allow the washing liquid injection mechanism and the wiper to be fixed to a horizontal support that is rotatably movably fixed to landing legs arranged so as to be spaced apart from each other on a bottom surface of the main frame of the aircraft module.

Also, the car wash module may allow the washing liquid injection mechanism and the wiper to be fixed to articulated robot arms which protrude from a center portion of a bottom surface of the main frame of the aircraft module.

Also, the drone-type smart car wash robot may further include a base station that is installed in a setting position and in which a washing liquid supply device and a wiper replacement device are provided, so that the aircraft module lands on the base station to perform supply and replenishment of the washing liquid and replacement of the wiper.

Also, the controller may include a base station position information management unit that stores and manages position information of the base station in a memory, an automatic maneuvering flight management unit that lands the aircraft module on a position of the base station by automatically maneuvering the aircraft module, and moves the aircraft module from the base station to a vehicle on which car wash is currently performed by automatically maneuvering the aircraft module, and a car wash progressing state detection/management unit that detects car wash progressing state information at a point of time when the aircraft module moves to the base station for replenishment of the washing liquid or replacement of the wiper while performing car wash on the vehicle, stores the detected information in the memory, and allows the car wash module of the aircraft module returned to the vehicle from the base station to perform the subsequent car wash in succession to the last car wash progressing state based on the car wash progressing state information.

Also, the drone-type smart car wash robot may further include a wireless charging module that is installed in any one selected from the aircraft module and the base station to perform wireless charging.

Also, the controller may further include a reservation car wash management unit that allows car wash on the vehicle to be performed by the vehicle scanning module and the car wash module while allowing the aircraft module to fly in an unmanned manner in such a manner as to be automatically maneuvered at a setting time according to a car wash time schedule regardless of presence and absence of the operator according to car wash time schedule setting performed by the operator.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIGS. 1 and 2 are configuration examples showing a drone-type smart car wash robot according to an embodiment of the present invention;

FIGS. 3 to 5 are perspective views showing a drone-type smart car wash robot according to an embodiment of the present invention;

FIG. 6 is a configuration view showing a drone-type smart car wash robot according to an embodiment of the present invention;

FIGS. 7 and 8 are control configuration views showing a drone-type smart car wash robot according to an embodiment of the present invention;

FIG. 9 is an example of a drone-type smart car wash robot according to an embodiment of the present invention including a base station;

FIG. 10 is a control configuration view showing a drone-type smart car wash robot according to an embodiment of the present invention including a base station;

FIG. 11 is a configuration block diagram showing a drone-type smart car wash robot according to an embodiment of the present invention including a wireless charging module; and

FIG. 12 is a control configuration view showing a drone-type smart car wash robot according to an embodiment of the present invention including a controller having a reservation car wash management unit.

### DETAILED DESCRIPTION OF EXEMPLARY EMBODIMENTS

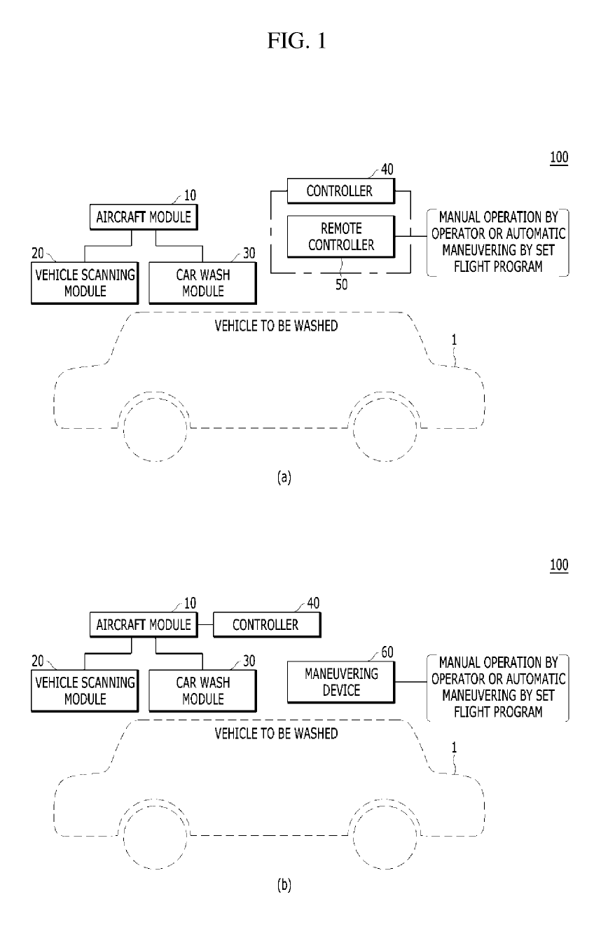

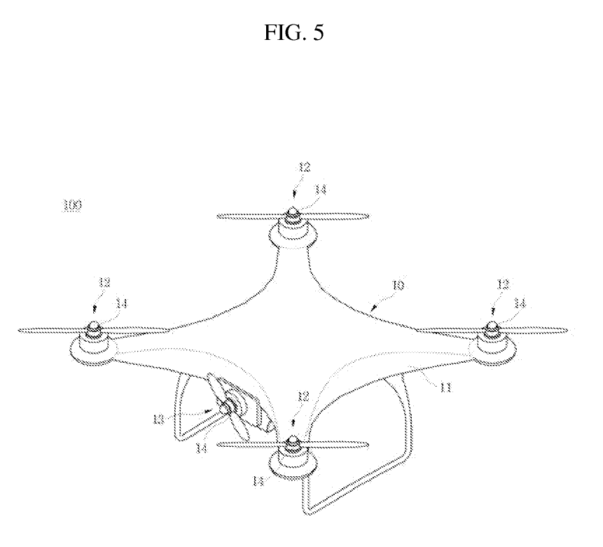

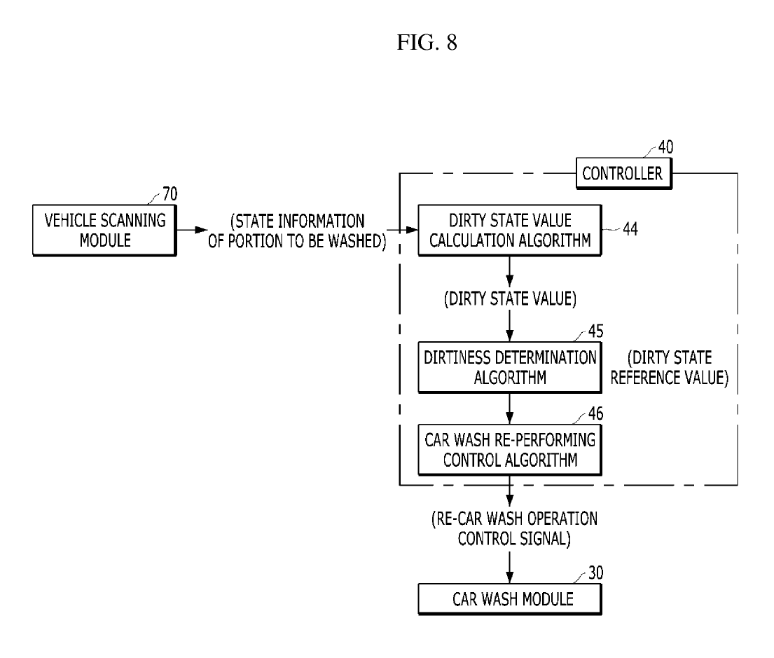

Hereinafter, embodiments according to the present invention will be described with reference to FIGS. 1 to 12. Meanwhile, in the drawings and detailed description, illustration and description of the configuration and operation which can be easily known by those skilled persons in the related art from a general drone, an unmanned flight, car wash, a three-dimensional (3D) scanner, a camera, a remote controller, and the like will be simplified or omitted. In particular, in the illustration of the drawings and detailed descriptions, detailed description and illustration of specific technical configurations and operations of elements which are not associated directly with the technical features of the present invention will be omitted, and only technical configuration which is associated with the present invention will be simply illustrated and described.

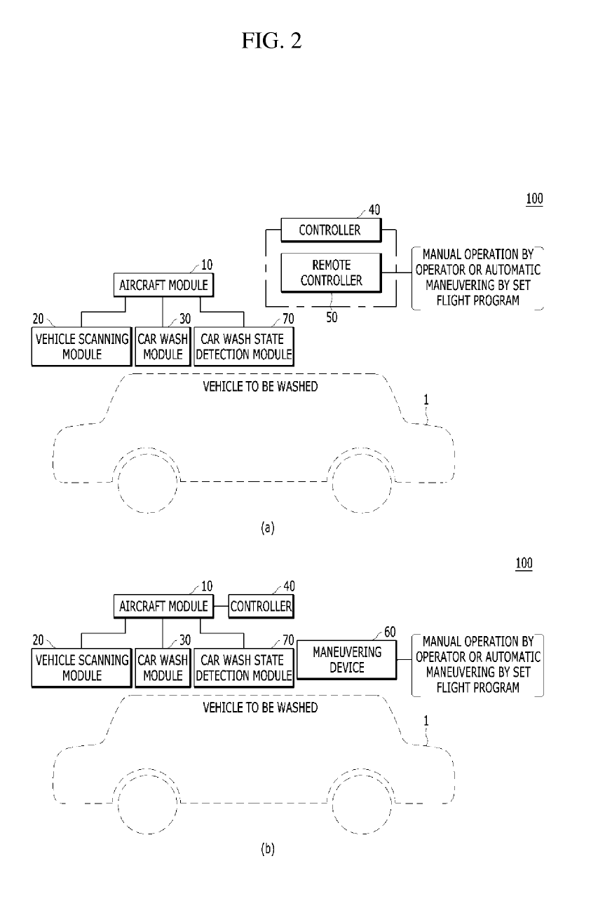

A drone-type smart car wash robot 100 according to an embodiment of the present invention may include an aircraft module 10, a vehicle scanning module 20, a car wash module 30, and a controller 40 as shown in FIG. 1, and further include a car wash state detection module 70 as shown in FIG. 2.

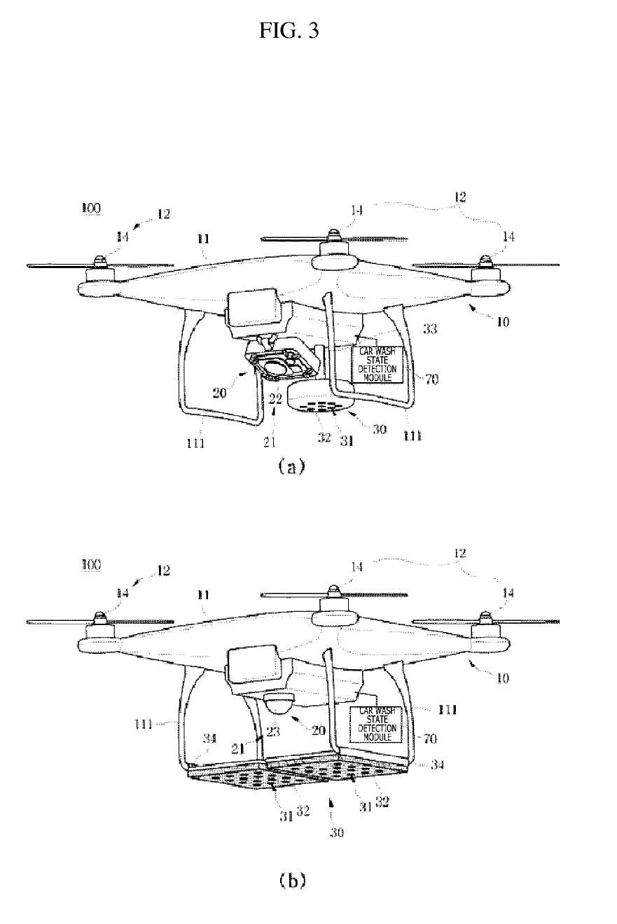

The aircraft module 10 flies in an unmanned manner while being manually operated by an operator on the ground or automatically maneuvered by a set flight program. Here, the aircraft module 10 flies in an unmanned manner in such a manner as to be automatically maneuvered at a setting time according to a car wash time schedule regardless of the presence and absence of an operator according to car wash time schedule setting performed by the operator. In this manner, the aircraft module 10 may include a main frame 11, a vertical movement propulsion device 12, and a horizontal movement propulsion device 13, as shown in FIGS. 3 to 5.

The main frame 11 is a body portion in which the vehicle scanning module 20, the car wash module 30, and the car wash state detection module 70 are mounted. The vertical movement propulsion device 12 includes one or more propellers 14 which are vertically installed in the main frame 11, and the vertical movement propulsion device 12 according to an embodiment of the present invention includes a plurality of propellers 14 arranged so as to be spaced apart from one another. The horizontal movement propulsion device 13 may include one or more propellers 14 horizontally installed in the main frame 11. The horizontal movement propulsion device 13 according to an embodiment of the present invention includes a single propeller 14 arranged in a lower portion of the main frame 11. Here, the horizontal movement propulsion device 13 may be formed of an air injection type propeller structure instead of a propeller.

Obviously, the aircraft module 10 may be formed to have various structures having an air vehicle configuration different from that of the aircraft module 10.

The vehicle scanning module 20 is mounted in the aircraft module 10, and performs scanning on a vehicle 1 to be washed while moving integrally with the aircraft module 10. In this manner, the vehicle scanning module 20 may include a 3D scanner 21 that performs 3D scanning on the vehicle to be washed and transmits vehicle scan information to the controller 40. Here, the 3D scanner 21 may include a general camera 22 of which a photographing angle is limited as shown in (a) of FIG. 3, or a hemispherical camera 23 of which omnidirectional photographing is possible as shown in (b) of FIG. 3.

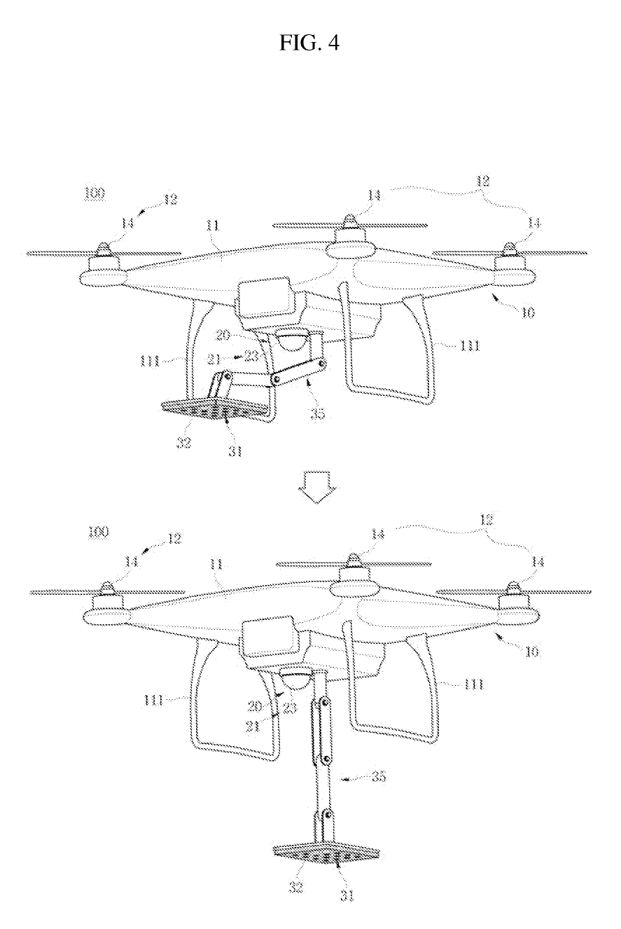

The car wash module 30 is mounted in the aircraft module 10, and performs car wash on the vehicle 1 to be washed while moving integrally with the aircraft module 10. Such a car wash module 30 may include a washing liquid injection mechanism 31 that injects a washing liquid and a wiper 32 that wipes a surface of the vehicle to be washed, as shown in FIGS. 3 and 4. As the material of the wiper 32, a cloth material, a textile material, a sponge, or the like may be used.

Here, the car wash module 30 protrudes from a center portion of a bottom surface of the main frame 11 of the aircraft module 10 as shown in (a) of FIG. 3, and allows the washing liquid injection mechanism 31 and the wiper 32 to be fixed to a vertical support 33 whose length is vertically adjusted. In addition, the car wash module 30 may allow the washing liquid injection mechanism 31 and the wiper 32 to be fixed to a horizontal support 34 that is rotatably movably fixed to landing legs 111 arranged so as to be spaced apart from each other on a bottom surface of the main frame 11 of the aircraft module 10 as shown in (b) of FIG. 3. The car wash module 30 may allow the washing liquid injection mechanism 31 and the wiper 32 to be fixed to articulated robot arms 35 which protrude from the center portion of the bottom surface of the main frame 11 of the aircraft module 10 as shown in FIG. 4. In a structure in which the washing liquid injection mechanism 31 and the wiper 32 are fixed to the articulated robot arms 35, a human hand operation may be implemented to increase car wash efficiency. Here, the car wash module 30 has a complex configuration having at least two of a structure including the vertical support 33, a structure including the horizontal support 34, and a structure including the articulated robot arms 35, and therefore a specific structure may be selectively used according to a car wash type.

The car wash state detection module 70 detects state information of a portion (portion to be washed) in which car wash has been performed by the car wash module 30. For this, the car wash state detection module 70 may include a car wash state information detection sensor for detecting state information a portion to be washed. Unlike this, the car wash state detection module 70 may be integrated with the vehicle scanning module 20.

The controller 40 may include a remote controller 50 that is carried by an operator as shown in (a) of FIG. 1 to remotely control operations of the aircraft module 10, the vehicle scanning module 20, the car wash module 30, and the car wash state detection module 70, or may be installed in the aircraft module 10 as shown in (b) of FIG. 1 and directly connected to the aircraft module 10, the vehicle scanning module 20, the car wash module 30, and the car wash state detection module 70 to perform control. Here, when the controller 40 is installed in the aircraft module 10, the operator may transmit various control signals to the controller 40 through a maneuvering device 60.

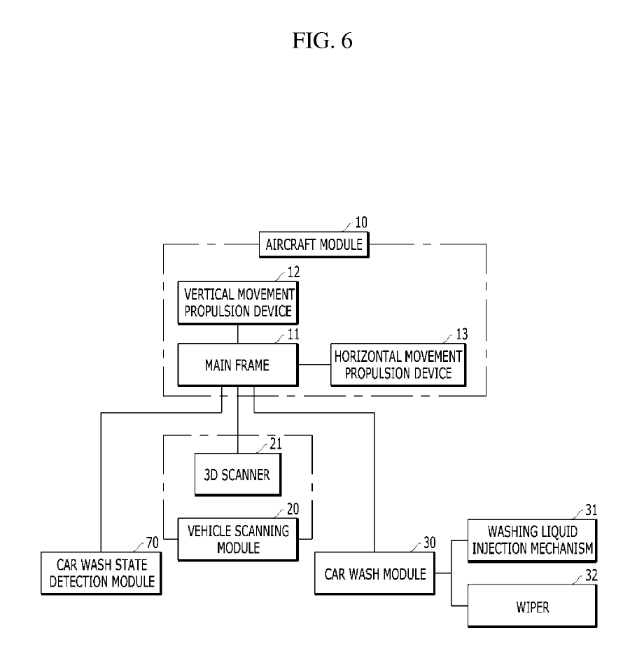

Here, the controller 40 according to an embodiment of the present invention may include a car wash preliminary information calculation algorithm 41, a flight path calculation algorithm 42, and a car wash operation control signal calculation algorithm 43, as shown in FIG. 6.

The car wash preliminary information calculation algorithm 41 is an algorithm that calculates shape information and dirty state information of the vehicle to be washed from the vehicle scan information transmitted from the 3D scanner 21 of the vehicle scanning module 20. The calculation of the shape information and the dirty state information of the vehicle to be washed may be performed through image analysis with respect to image information included in the vehicle scan information. The flight path calculation algorithm 42 is an algorithm that calculates a flight path for performing car wash of the aircraft module 10 corresponding to the shape information and dirty state information of the vehicle to be washed. The flight path for performing car wash may be calculated by applying the shape of the vehicle to be washed, a position of the dirty portion, and a dirty state degree value to a path generation algorithm, and as the path generation algorithm, a neural network algorithm, a genetic algorithm, a fuzzy algorithm, and the like may be applied. The car wash operation control signal calculation algorithm 43 is an algorithm that calculates a car wash operation control signal corresponding to the dirty state information of the vehicle to be washed. Such a car wash operation control signal calculation algorithm 43 may quantify a degree of the dirty state of the vehicle or a range of the dirty portion, and calculate a car wash operation control value such as a washing liquid injection quantity, a washing liquid injection range, a pressing force of the wiper on the dirty portion, a wiper operation pattern, and the like according to the dirty state degree value or the position value of the dirty portion.

Such a controller 40 controls the car wash module 30 depending on the car wash operation control signal while controlling the aircraft module 10 to fly along the flight path for performing car wash in an unmanned manner.

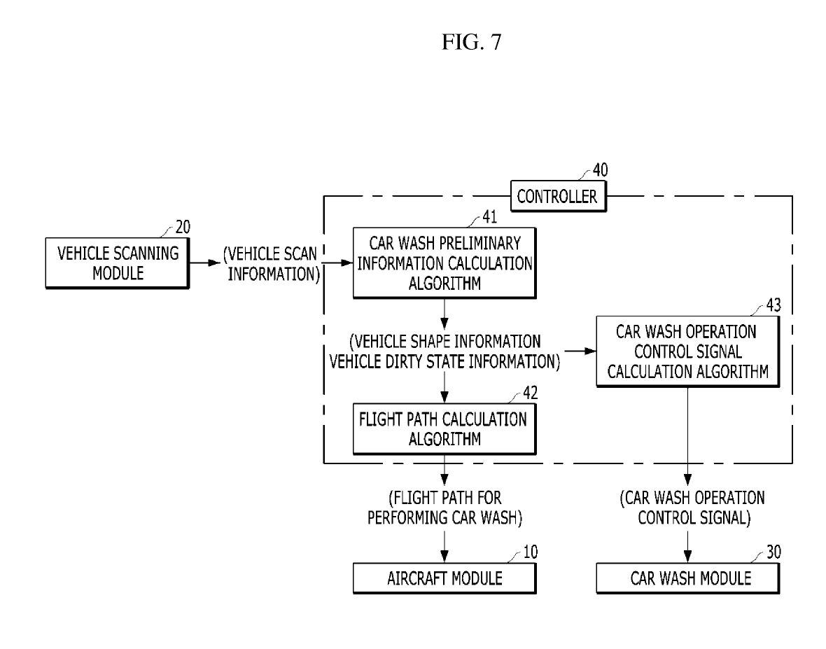

The controller 40 according to an embodiment of the present invention may include a dirty state value calculation algorithm 44, a dirtiness determination algorithm 45, and a car wash re-performing control algorithm 46 as shown in FIG. 7.

The dirty state value calculation algorithm 44 is an algorithm that receives state information of the portion to be washed from the car wash state detection module 70 and calculates a dirty state value from the state information of the portion to be washed. Here, the dirty state value may be a value obtained by quantifying a degree of dirtiness. The dirtiness determination algorithm 45 is an algorithm that determines, when a dirty state reference value is set, whether the dirty state value calculated from the dirty state value calculation algorithm 44 is the set dirty state reference value or more. The car wash re-performing control algorithm 46 is an algorithm that generates, when the dirty state value calculated from the dirty state value calculation algorithm 44 is the dirty state reference value or more, an operation control signal for controlling operations of the aircraft module 10 and the car wash module 30 so that car wash on the portion to be washed is performed again.

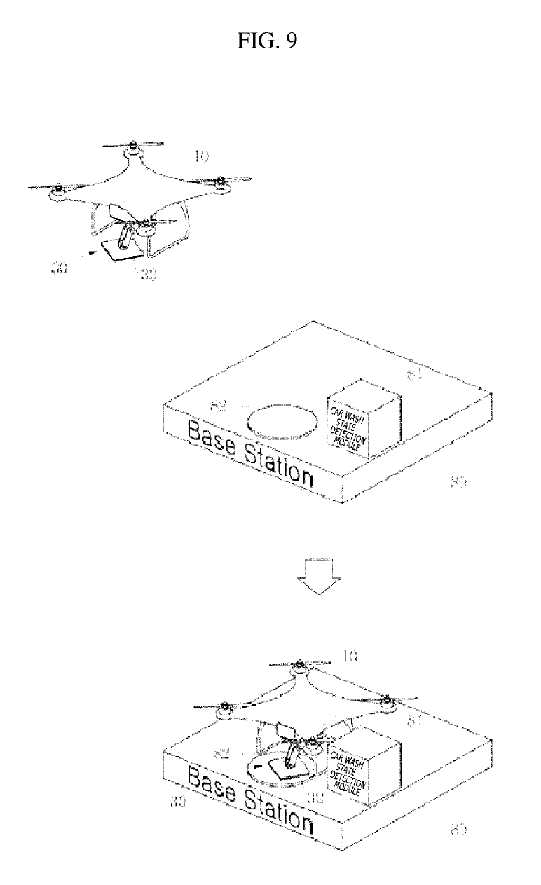

Meanwhile, the drone-type smart car wash robot 100 according to an embodiment of the present invention may include a base station 80 that is installed in a setting position as shown in FIG. 9 and in which a washing liquid supply device 81 and a wiper replacement device 82 are provided. When the washing liquid or the wiper is required to be replenished or replaced, the aircraft module 10 may move to the base station 80 and then land to perform supply and replenishment of the washing liquid and replacement of the wiper.

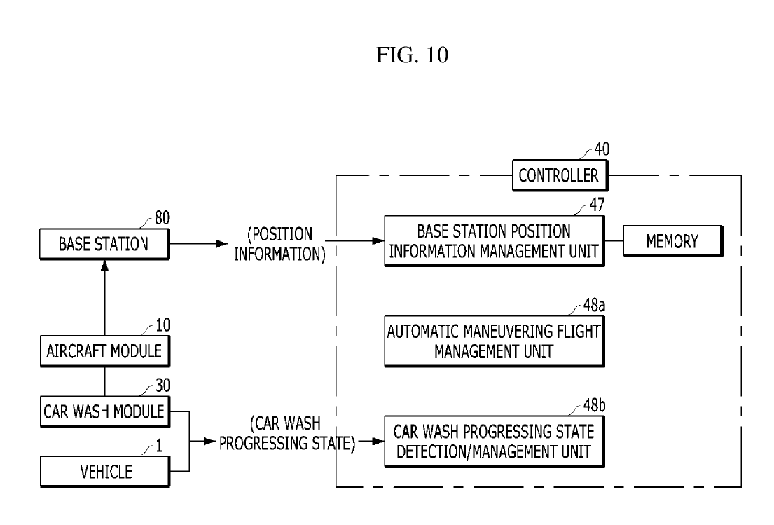

For this, the controller 40 may include a base station position information management unit 47, an automatic maneuvering flight management unit 48a, a car wash progressing state detection/management unit 48b, as shown in FIG. 10.

The base station position information management unit 47 stores and manages position information of the base station 80 in a memory. Here, the position information of the base station 80 may be searched or detected in real-time by the controller 40. Alternatively, the position information of the base station 80 may be set in advance and stored in the controller 40.

The automatic maneuvering flight management unit 48a lands the aircraft module 10 on a position of the base station 80 by automatically maneuvering the aircraft module 10, and moves the aircraft module 10 from the base station 80 to a vehicle on which car wash is currently performed by automatically maneuvering the aircraft module 10.

The car wash progressing state detection/management unit 48b detects car wash progressing state information at a point of time when the aircraft module 10 moves to the base station 80 for replenishment of the washing liquid or replacement of the wiper while performing car wash on the corresponding vehicle, stores the detected information in the memory, and allows the car wash module 30 of the aircraft module 10 returned to the corresponding vehicle from the base station 80 to perform the subsequent car wash in succession to the last car wash progressing state based on the car wash progressing state information.

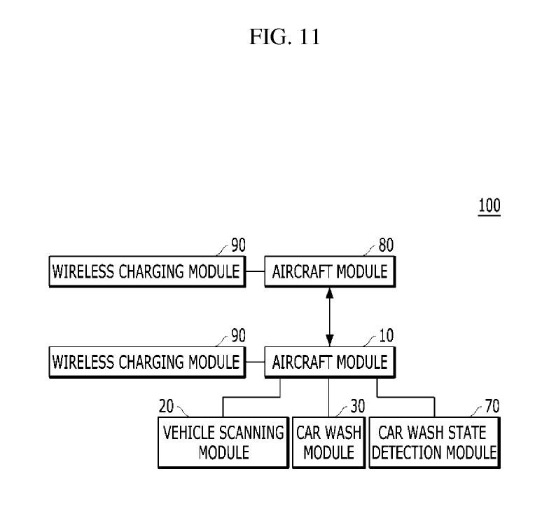

The drone-type smart car wash robot 100 according to an embodiment of the present invention may allow a wireless charging module 90 to be installed in the aircraft module 10 and the base station 80 as shown in FIG. 11. Such a wireless charging module 90 supplies a power source to the base station 80 and the aircraft module 10 by performing wireless charging.

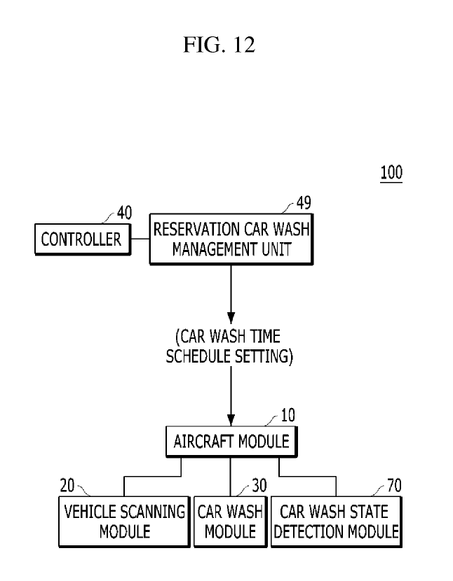

In addition, in the drone-type smart car wash robot 100 according to an embodiment of the present invention, the controller 40 may include a reservation car wash management unit 49 as shown in FIG. 12, so that car wash time schedule setting and reservation car wash control may be performed. For this, the reservation car wash management unit 49 may allow car wash on the corresponding vehicle to be performed by the vehicle scanning module 20 and the car wash module 30 while allowing the aircraft module 10 to fly in an unmanned manner in such a manner as to be automatically maneuvered at a setting time according to a car wash time schedule regardless of the presence and absence of an operator according to the car wash time schedule setting performed by the operator.

According to the drone-type smart car wash robot 100 according to an embodiment of the present invention configured as above, the vehicle scanning module 20 may be provided in the aircraft module 10 which flies around a vehicle in an unmanned manner so that scanning may be performed on the vehicle 1 to be washed, and dirty state information and shape information of the vehicle and a flight path for performing car wash and a car wash operation control signal corresponding to these information may be calculated in a customized manner by the car wash preliminary information calculation algorithm 41, the flight path calculation algorithm 42, and the car wash operation control signal calculation algorithm 43 of the controller 40, and therefore the car wash module 30 of the aircraft module 10 which flies along the flight path for performing car wash may intelligently and automatically perform car wash according to the car wash operation control signal calculated in the customized manner. As a result, it is possible to minimize constraints of time and place for car wash, and frequently perform car wash in a simple and easy manner.

In addition, according to the drone-type smart car wash robot 100 according to an embodiment of the present invention, only a dirty portion having a reference value or more may be washed through vehicle dirty state information calculated by the vehicle scanning module 20, thereby reducing car wash costs and increasing car wash efficiency. In addition, according to the drone-type smart car wash robot 100 according to an embodiment of the present invention, state information of a portion to be washed may be detected by the car wash state detection module 70 mounted in the aircraft module 10, and car wash may be performed again when a dirty state value calculated from the state information of the portion to be washed is a dirty state reference value or more, and therefore car wash may be performed precisely and cleanly.

By the drone-type smart car wash robot according to the present invention, car wash may be performed through unmanned flight by a drone, and therefore it is possible to minimize constraints of time and place for car wash, and frequently perform car wash in a simple and easy manner.

In addition, by the drone-type smart car wash robot according to the present invention, only a dirty portion having a reference value or more may be washed through vehicle dirty state information calculated by the vehicle scanning module, thereby reducing car wash costs and increasing car wash efficiency. In addition, by the drone-type smart car wash robot according to the present invention, car wash may be performed again by automatically detecting a state in which the portion to be washed is not sufficiently washed, and therefore car wash may be performed precisely and cleanly.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A drone-type smart car wash robot comprising:
an aircraft module that flies in an unmanned manner by any one selected from manual operation by an operator on the ground and automatic maneuvering by a set flight program;
a vehicle scanning module that is mounted in the aircraft module and performs scanning on a vehicle to be washed while moving integrally with the aircraft module;
a car wash module that is mounted in the aircraft module and performs car wash while moving integrally with the aircraft module; and
a controller that controls operations of the aircraft module, the vehicle scanning module, and the car wash module,
wherein the vehicle scanning module includes a three-dimensional (3D) scanner that performs 3D scanning on the vehicle to be washed and transmits vehicle scan information to the controller.

2. (canceled)

3. The drone-type smart car wash robot of claim 3, wherein the controller includes a car wash preliminary information calculation algorithm that calculates shape information and dirty state information of the vehicle to be washed from the vehicle scan information transmitted from the 3D scanner, and controls the operations of the aircraft module and the car wash module according to the calculated shape information and dirty state information of the vehicle to be washed.

4. The drone-type smart car wash robot of claim 3, wherein the controller further includes a flight path calculation algorithm that calculates a flight path for performing car wash of the aircraft module corresponding to the shape information and dirty state information of the vehicle to be washed and a car wash operation control signal calculation algorithm that calculates a car wash operation control signal corresponding to the dirty state information of the vehicle to be washed, and controls the car wash module according to the car wash operation control signal while controlling the aircraft module so that the aircraft module flies along the flight path for performing car wash in an unmanned manner.

5. The drone-type smart car wash robot of claim 1, further comprising:
a car wash state detection module that detects state information of a portion (a portion to be washed) in which car wash has been performed by the car wash module.

6. The drone-type smart car wash robot of claim 5, wherein the car wash state detection module is any one of the car wash state detection module including a car wash state information detection sensor for detecting state information of the portion to be washed and the car wash state detection module integrated with the vehicle scanning module.

7. The drone-type smart car wash robot of claim 5, wherein the controller includes
a dirty state value calculation algorithm that receives state information of the portion to be washed from the car wash state detection module and calculates a dirty state value from the state information of the portion to be washed,
a dirtiness determination algorithm that determines, when a dirty state reference value is set, whether the dirty state value calculated from the dirty state value calculation algorithm is the set dirty state reference value or more, and
a car wash re-performing control algorithm that generates, when the dirty state value calculated from the dirty state value calculation algorithm is the dirty state reference value or more, an operation control signal for controlling the operations of the aircraft module and the car wash module so that car wash on the portion to be washed is performed again.

8. The drone-type smart car wash robot of claim 1, wherein the aircraft module includes
a main frame in which the vehicle scanning module and the car wash module are mounted,
a vertical movement propulsion device that includes one or more propellers vertically installed in the main frame, and
a horizontal movement propulsion device that includes one or more propellers horizontally installed in the main frame.

9. The drone-type smart car wash robot of claim 1, wherein the car wash module includes
a washing liquid injection mechanism that injects a washing liquid, and
a wiper that wipes a surface of the vehicle to be washed.

10. The drone-type smart car wash robot of claim 9, wherein the car wash module protrudes from a center portion of a bottom surface of the main frame of the aircraft module, and allows the washing liquid injection mechanism and the wiper to be fixed to a vertical support whose length is vertically adjusted.

11. The drone-type smart car wash robot of claim 9, wherein the car wash module allows the washing liquid injection mechanism and the wiper to be fixed to a horizontal support that is rotatably movably fixed to landing legs arranged so as to be spaced apart from each other on a bottom surface of the main frame of the aircraft module.

12. The drone-type smart car wash robot of claim 9, wherein the car wash module allows the washing liquid injection mechanism and the wiper to be fixed to articulated robot arms which protrude from a center portion of a bottom surface of the main frame of the aircraft module.

13. The drone-type smart car wash robot of claim 9, further comprising:
a base station that is installed in a setting position and in which a washing liquid supply device and a wiper replacement device are provided, so that the aircraft module lands on the base station to perform supply and replenishment of the washing liquid and replacement of the wiper.

14. The drone-type smart car wash robot of claim 13, wherein the controller includes
a base station position information management unit that stores and manages position information of the base station in a memory,
an automatic maneuvering flight management unit that lands the aircraft module on a position of the base station by automatically maneuvering the aircraft module, and moves the aircraft module from the base station to a vehicle on which car wash is currently performed by automatically maneuvering the aircraft module, and
a car wash progressing state detection/management unit that detects car wash progressing state information at a point of time when the aircraft module moves to the base station for replenishment of the washing liquid or replacement of the wiper while performing car wash on the vehicle, stores the detected information in the memory, and allows the car wash module of the aircraft module returned to the vehicle from the base station to perform the subsequent car wash in succession to the last car wash progressing state based on the car wash progressing state information.

15. The drone-type smart car wash robot of claim 13, further comprising:
a wireless charging module that is installed in any one selected from the aircraft module and the base station to perform wireless charging.

16. The drone-type smart car wash robot of claim 1, wherein the controller further includes a reservation car wash management unit that allows car wash on the vehicle to be performed by the vehicle scanning module and the car wash module while allowing the aircraft module to fly in an unmanned manner in such a manner as to be automatically maneuvered at a setting time according to a car wash time schedule regardless of presence and absence of the operator according to car wash time schedule setting performed by the operator.
